(19) United States
(12) Patent Application Publication
(10) Pub. No.: US 2022/0266577 A1
(43) Pub. Date: Aug. 25, 2022

(54) COMPOSITE MATERIALS FOR ORTHODONTIC APPLICATIONS

(71) Applicant: uLab Systems, Inc., Memphis, TN (US)

(72) Inventors: Krishnamohan SHARMA, Milpitas, CA (US); Huafeng WEN, Redwood Shores, CA (US)

(73) Assignee: uLab Systems, Inc., Memphis, TN (US)

(21) Appl. No.: 17/651,382

(22) Filed: Feb. 16, 2022

Related U.S. Application Data
(60) Provisional application No. 63/151,452, filed on Feb. 19, 2021.

(51) Int. Cl. B32B 27/08; B32B 3/26; B32B 7/022; B32B 27/36; B32B 27/40

(52) U.S. Cl. CPC B32B 27/08; B32B 3/266; B32B 7/022; B32B 27/36; B32B 27/40; A61C 7/08

(57) ABSTRACT

Composite materials for orthodontic applications are described herein. Generally, the multi-layer composite material assembly may comprise a first polymeric layer having a first flexural modulus, a second polymeric layer formed upon the first polymeric layer and having a second flexural modulus which is lower than the first flexural modulus, and a third polymeric layer formed upon the second polymeric layer such that the second polymeric layer is positioned between the first polymeric layer and the third polymeric layer, wherein the third polymeric layer has a third flexural modulus equivalent to the first flexural modulus. An additional fourth polymeric layer may be formed upon the third polymeric layer as well.

### CROSS-REFERENCE TO RELATED APPLICATIONS

This application claims priority to U.S. Prov. App. 63/151,452 filed Feb. 19, 2021, the content of which is incorporated herein by reference in its entirety.

### FIELD OF THE INVENTION

The present invention relates to methods and apparatus for orthodontics. More particularly, the present invention relates to methods and apparatus for creating or fabricating materials which are optimized for use in orthodontic aligner treatments.

### BACKGROUND OF THE INVENTION

Orthodontics is a specialty of dentistry that is concerned with the study and treatment of malocclusions which can result from tooth irregularities, disproportionate facial skeleton relationships, or both. Orthodontics treats malocclusion through the displacement of teeth via bony remodeling and control and modification of facial growth.

This process has been accomplished by using a number of different approaches such as the application of static mechanical forces to induce bone remodeling, thereby enabling teeth to move. Oftentimes, treatments include the use of aligners which are positioned upon the teeth to effect the movement of one or more teeth and these aligners are typically fabricated from polymers which are thermoformed to the patient's dentition.

However, the polymeric aligners may become formed in a manner which makes the aligners too rigid, and may apply more force than required, in which case the patient may experience discomfort when first worn. Over time, the aligner may become ineffective (due to stress relaxation) in further moving the position of the teeth, in which case they do not achieve the objective of moving teeth. Alternatively, the aligners may be formed to be too soft, and may apply inadequate amount of force, such aligners may be ineffective in moving the teeth as the force imparted may be too low.

There is a need for customizing the sustainable force applied onto teeth or an individual tooth to efficiently move them without causing any discomfort to accomplish the objective aligners.

In yet another embodiment, there is a need for optimizing the amount of force applied to the teeth over the course of treatment, for example, the stress applied to the teeth and rigidity of the aligners in the early days of therapy may be different compared to the latter days of therapy.

Accordingly, there exists a need for efficiently and effectively providing a range of polymeric materials which are optimized/customized for aligners and other orthodontic applications while remaining cost effective.

### SUMMARY OF THE INVENTION

The materials disclosed may be utilized for orthodontic aligners which apply a optimal initial force and provide for improved stress relaxation properties. In one variation, such an aligner fabricated from the materials may impart a force of, e.g., 100-4000 grams, during a treatment over a period of, e.g., 5-7 days or higher. The exact force values exerted by aligners depend on applied strain, intrinsic nature of materials, stress relaxation time, thickness, surface area changes before and after thermo-forming or within in the aligner. Such a force profile may provide for patient comfort and efficient tooth movement. Furthermore, such an aligner may be customizable to provide any number of force profiles for tooth movement according to individual patient treatments, as described in further detail herein. Additionally, such aligners may be fabricated from using any safe medical grade or biodegradable resins such as polyesters, co-polyesters, polyamides, polyurethanes, polycarbonates, polyolefins, polypropylenes, polyethylenes, polyacrylic, polylactic, polycaprolactone, polyhydroxyalkanoate, polybutylene succinate, starch based, polysaccharides, silicones, and innumerable others resins and their combinations known to those skilled in the art. Moreover, such an aligner may be direct 3D printed or thermoformed within an orthodontic office locally.

It has been shown that multi-layer polymeric films can be made by manipulation of “hard” layers (flexural modulus ranging at or above, e.g., 1000 MPa or particularly ranging from, e.g., 1000-2500 MPa), and “soft” layers (flexural modulus ranging from, e.g., 50-500 MPa) to optimize the stress relaxation properties of aligners. However, further optimization may be accomplished by the inclusion of perforations at least partially or over the entirety of the hard and/or soft layers can be exploited to form interdigitated composite layers that may not only provide controllable stress relaxation properties but enable the exertion of different amounts of force applied by the composite layers. For instance, an orthodontic appliance such as an aligner which may be formed with such a multi-layer composite film may be customized to apply differing amounts of force over different regions of the aligner. Additionally, using a combination of “hard” layers (e.g., without any need for “soft” layer as reported in the literature), the stress forces applied can be controlled to last for longer periods of time. One advantage of incorporating perforations is that one can selectively alter the stress forces in different segments of aligners formed with the composite films by selectively hardening or weaking stress forces, thereby employing variable amounts of forces on different teeth or selected tooth within an aligner, and offer efficient tooth movement without causing any discomfort to the patient. Aside from aligners, other orthodontic appliance may also be formed using the composite films.

One variation of a combination of polymer materials applied in a predetermined layered configuration may include a first polymeric layer such as a thermoplastic polymers, polyurethanes or polyesters or polyamides and a second polymeric layer layered upon the first polymeric layer and a third polymeric layer such as a thermoplastic polyester layered upon the second polymeric layer such that the second polymeric layer is layered between the first and third polymeric layers. The first and third polymeric layers may be the same or similar material.

A second variation may utilize a combination of a first polymeric layer of a thermoplastic polyester, a second polymeric layer of an thermoplastic polyurethane, or polyamide and a third polymeric layer of a thermoplastic polyester where the first and third polymeric layers may be the same or similar material. The respective combination of polymers in their layered configuration may yield a force decay over time which remains at a relatively higher initial level and remains at a higher level over the decay period.

A third variation may include a first polymeric layer such as a thermoplastic polyester, a second polymeric layer of an aromatic thermoplastic polyurethane, and a third polymeric layer such as a thermoplastic polyester.

When polymeric layers with an elastic modulus over 1000 MPa are layered, where a first polymeric layer may have a second polymeric layer layered upon the first polymeric layer and a third polymeric layer may be layered upon the second polymeric layer such that this second layer is sandwiched between the first polymeric layer and the third polymeric layer, the overall composite material formed may provide the desirable force.

While the specific materials used for each layer may comprise the materials described above, the material properties of each layer may be generalized as “hard” layers. For example, polymeric materials which are generally considered to be “soft” may have a flexural modulus ranging from, e.g., 50-500 MPa, while polymeric materials which are generally considered to be “hard” may have a flexural module ranging from, e.g., 1000-2500 MPa. Hence, the various layers may be provided in a number of different configurations to provide a resultant composite material which may be used to thermoform an aligner that is made of two or three layers. One variation may utilize a combination of layers where each layer is considered to be a “hard” polymer so that the first polymeric layer may have a flexural modulus of, e.g., 1800-2000 MPa, the second polymeric layer may have a flexural modulus of, e.g., 1300-1500 MPa, and the third polymeric layer may have a flexural modulus of, e.g., 1800-2000 MPa. Another variation may utilize a combination of layers where each layer is considered to be a “hard” polymer so that the first polymeric layer may have a flexural modulus of, e.g., 1200-1600 MPa, the second polymeric layer may have a flexural modulus of, e.g., 1000-1200 MPa, and the third polymeric layer may have a flexural modulus of, e.g., 1200-1600 MPa. In such variation, the first and third polymeric layers may have a first flexural modulus which is equivalent to one another while the second polymer layer which is positioned between the first and third polymeric layers may be considered as a “hard” polymer but it may have a second flexural modulus which is less than the first flexural modulus.

Having a perforated polymeric material may facilitate the stabilization of the composite structure and may enable controlling the force values and decay over time due to diffusion or interdigitation of thermoplastic polymers into each other. The formation of composite structure and enhancement of surface area at the interfaces of layers through patterning may enhance adhesion and elasticity under stress. Such a combination of layers form the composite material having an elongation at break of over 100% or 250% and the elongate at yield is over 4% or 5% or even higher.

With the various polymeric materials and the variety of combinations available, the aligners formed for patient treatment may be tuned or customized. For example, a first aligner fabricated from a first composite material to apply a first force response (e.g., relatively high force response), and a second or subsequent aligner fabricated from a second composite material to apply a second force response (e.g., relatively lower force response than the first force response). The use of different force response decay profiles may allow for the user to balance patient comfort against the moment force applied by the aligner such that a relatively higher force may be applied early but which decays relatively quickly.

Another example may include the user of a first aligner fabricated from a first composite to impart a relatively higher initial force of, e.g., 1000 to 4000 grams, for a first treatment period of, e.g., first 4 weeks. A second aligner fabricated from a second composite may be used to impart a moderate force of, e.g., 500 to 1000 grams and a third or subsequent aligner may be fabricated from a third composite material to impart a relatively low consistent force of, e.g., 100 to 500 grams, over the course of a treatment or in a different order as the practitioner, such as an orthodontist, may deem appropriate given a case. The force applied by different aligners may vary depending upon the applied strain (or stretching) or gap between teeth.

Any variety of treatment options and force response levels may be used in different combinations depending upon the materials used for fabricating the aligners.

A composite material formed to have a “hard” first polymeric layer and a “hard” third polymeric layer each with a flexural modulus of, e.g., 1600 MPa (250 Microns), and an intermediate “hard” second polymeric layer with a flexural modulus of, e.g., 1000-1500 MPa (250 Microns), as described. However, an alternative variation may include a two-layer composite material. In the two-layer embodiment, a “hard” first polymeric layer may have a first flexural modulus of, e.g., 500-1400 MPa, and a “hard” second polymeric layer may have a second flexural modulus of, e.g., 1400-2100 MPa, which may be considered “hard” but where the first flexural modulus is less than the second flexural modulus.

In either the three-layer composite material or the two-layer composite material, the polymers used may be varied so long as the flexural modulus values remain within the prescribed ranges.

With any of the composite materials described herein, additional processing may be performed on the materials to further improve their various properties depending upon the desired results. For example, the composite material may be exposed to one or more heat treatments, for example, to improve the relative stress relaxation properties where a composite material may be annealed at or over 65 degrees C. over a minimum treatment time of 1 hour or 20 hours either under dry or wet conditions. In other variations, the material may be annealed at or over 80 degrees C. over a minimum treatment time of 10 hours. The resulting force decay profile of an untreated sample relative to the force decay profile of an annealed sample may illustrate how the annealed sample may provide an initial force which is lower than the untreated sample but the response force over time remains at a relatively higher level over time. Such a heat treatment process may be applied to any of the composite materials described herein to alter the mechanical properties accordingly.

Aside from heat treatment, the process by which an aligner is thermoformed may also be altered. For a three-layer composite material (or for a two-layer composite), each of the layers may be thermoformed upon a mold of the patient's dentition separately from one another rather than as a multi-layer composite sheet which is thermoformed in a single step. A first polymeric layer may be initially thermoformed upon the dentition mold. Once the first polymeric layer has been deposited and formed, the second polymeric layer may be subsequently deposited and formed upon the first polymeric layer and the third polymeric layer may be subsequently deposited and formed upon the second polymeric layer to form the final multi-layer composite aligner.

As with heat treatment processing, the process of applying individual polymeric layers may be utilized for any of the composite materials described herein.

In yet another variation, one or more layers of the composite material may be perforated or otherwise incorporate one or more openings through the entire layer or just portions of the layer. A first polymeric layer and a third polymeric layer having a perforated or breathable polymeric second layer in between. The size, shape, and pattern of the openings may be varied depending upon the desired results and further enables the first and third polymeric layers to flow into and through the pores to provide for enhanced stress relaxation of the composite material. Such a variation in pore size, shape, dimensions, and spacing between the pores may be used to influence the translational and rotational forces advantageously. Additionally, one or more agents such as anti-microbial agents may be incorporated into the second polymeric layer. Furthermore, any or all of the individual layers may be fabricated from a bio-degradable polymer.

Yet another variation may incorporate the addition of a fourth polymeric layer where a first and third polymeric layer made from a “hard” polymer while the second polymeric layer may be made of a “soft” polymer. A fourth polymeric layer made of a “soft” or “hard” polymer may be applied either upon the first polymeric layer or upon the third polymeric layer again depending upon the desired results.

Yet another variation may have a first polymeric layer made of both “hard” and “soft” polymeric portions combined into a single layer. “Soft” polymeric layers or portions may be filled into the openings of hard polymers, resulting in a single layer with “hard” polymer layers or portions so that the combination of polymers may be adjoined to one another to form a singular layer.

Any of the variations and embodiments described above may be utilized for any of the composite materials described herein.

With respect to the combination of materials in forming the composite, any or all of the individual layers may also be optionally patterned with various perforations, pores, openings, slits, indentations, etc. in a number of different configurations to further alter certain mechanical properties of the overall resulting aligner formed from the composite materials. Because the orthodontic polymeric aligner shells are used to apply translational and/or rotational forces upon teeth to move them, the polymeric materials used in fabricating the aligners should ideally exhibit a tuned, predetermined level of mechanical properties, such as elasticity, stress relaxation, resistance to creep, etc. for exerting force upon the teeth to achieve desired results.

For example, application of an excessive amount of force upon the teeth may cause patient discomfort or may cause damage to their teeth. On the other hand, applying a reduced amount of force may not sufficiently move the teeth/tooth to their desired position. Also, teeth at different locations may need to experience different levels of forces to move them into desired location. Hence, in addition to the use of different polymeric layers as described herein, any or all of the polymeric sheet materials may be formed with features such as perforations, pores, openings, slits, indentations, etc. in a variety of patterns in such a way that the patterns offer a good balance of flexibility, elasticity, impact resistance, stress relaxation, and displacement and restoration forces. Such features may be defined over the entire polymeric layer or layers or they may be localized at predetermined areas of the polymeric layer such that these features are exhibited at preselected portions of the aligner ultimately formed from the layers. For instance, the patterns formed on the polymer layers may be positioned at selective locations in such a way that different amounts of force may be selectively applied to different teeth to customize the aligner for not only each patient, but for each tooth. The gaps in the patterned dental aligners may be closed upon thermoforming or optionally overcoated with a material such as a thin plastic material or alternatively filled with an elastic material to prevent accumulation of unwanted particles, biomass, or discoloration while in use. The patterns can also be applied at different thicknesses, for example, a thinner layer of material may be needed at an occlusal surface of the aligner but a thicker layer of material may be positioned near the gum regions to exert required forces.

Additionally and/or alternatively, a polymeric layer may be selectively rigidified using a pattern. For example, a rigid material such as plastics, composites, metallic substrates, etc. may be deposited onto a polymeric layer in a predetermined pattern to alter the translational and rotational force they exert upon the teeth or tooth when formed into an aligner. The deposition of rigid materials could be upon selected locations to customize the force exerted on each tooth. It is also possible to deposit the rigid materials using a 3D printing technique or extrusion or any other known methods.

An overcoat may also be laid over the deposited materials, if desired. Although, one pattern is illustrated, the deposited rigid materials may be laid or positioned in any pattern or configuration to achieve a desired translational, rotational, displacement and/or restoration forces that in a customized manner.

A polymeric layer may define clear areas upon the flattened material which correlate primarily to the buccal incisor area and hidden areas which correlate primarily to the lingual and posterior areas of the to-be-formed aligner. For the hidden areas, once the aligner has been formed, these areas are typically hidden from public view when the aligner is worn by the patient and because they remain hidden during use, alternative materials can be used along these hidden areas. For instance, opaque materials (non-transparent), metallic, ceramic, or mesh metallic sheets, etc. can be applied as well. Common based patterned forms can be premade and a set of sheet can be selected based on best matching to the premade set.

In another variation of a polymeric composite material with the defined region of a to-be-formed aligner having an integrated feature. In this example, a lingual bar may be integrated with the aligner to strengthen the aligner. A marked location along the region which corresponds to where the lingual bar is to be positioned may be calculated and marked upon the material. One or more wires may then be placed or integrated upon the marked location according to the marker and then formed along with the sheet into the aligner. The lingual bar may have a coupled glue sheet to secure its position. While a lingual bar is shown, any other orthodontic appliance or attachment may be used in the same or similar manner for integration upon the aligner.

While different features are discussed, the assembly and processes may incorporate any number of different features into a single system in any number of combinations. A single system provided may, for example, include or incorporate every feature described herein or it may include a select number of features depending upon the desired system.

In one variation, the multi-layer composite material assembly may generally comprise a first polymeric layer having a first flexural modulus between 1000-2500 MPa, wherein the first polymeric layer defines a thickness of at least 460 micron, a second polymeric layer formed upon the first polymeric layer and having a second flexural modulus different from the first flexural modulus.

In another variation, the multi-layer composite material assembly may generally comprise a first polymeric layer having a first flexural modulus of at least 2000 MPa, a second polymeric layer formed upon the first polymeric layer and having a second flexural modulus of at least 1360 MPa, and a third polymeric layer formed upon the second polymeric layer such that the second polymeric layer is positioned between the first polymeric layer and the third polymeric layer, wherein the third polymeric layer has a third flexural modulus of at least 2000 MPa.

In another variation, the multi-layer composite material assembly may generally comprise a first polymeric layer having at least one portion comprised of a first polymer having a first flexural modulus and at least one portion comprised of a second polymer adjoined to the first polymer and having a second flexural modulus, wherein the first polymeric layer forms a singular layer.

In another variation, the multi-layer composite material assembly may generally comprise a first polymeric layer having a first flexural modulus, a second polymeric layer formed upon the first polymeric layer and having a second flexural modulus and different than the first flexural modulus, a third polymeric layer formed upon the second polymeric layer such that the second polymeric layer is positioned between the first polymeric layer and the third polymeric layer, wherein the third polymeric layer has a third flexural modulus equivalent to the first flexural modulus, and a fourth polymeric layer formed upon the third polymeric layer such that fourth polymeric layer is opposite to the first polymeric layer, wherein the fourth polymeric layer has a fourth flexural modulus equivalent to the second flexural modulus.

In another variation, the multi-layer composite material assembly may generally comprise a first polymeric layer having a first flexural modulus, a second polymeric layer formed upon the first polymeric layer and having a second flexural modulus and different than the first flexural modulus, a third polymeric layer formed upon the second polymeric layer such that the second polymeric layer is positioned between the first polymeric layer and the third polymeric layer, wherein the third polymeric layer has a third flexural modulus equivalent to the second flexural modulus, and a fourth polymeric layer formed upon the third polymeric layer such that fourth polymeric layer is opposite to the first polymeric layer, wherein the fourth polymeric layer has a fourth flexural modulus equivalent to the first flexural modulus.

### BRIEF DESCRIPTION OF THE DRAWINGS

FIG. 1 shows a graph which various performance characteristics of different aligner types.

FIGS. 2A and 2B show an exemplary cross-sectional side view to illustrate how the various layers may be configured relative to one another.

FIGS. 3A and 3B show schematically a composite material formed to have a “hard” first polymeric layer and a “hard” third polymeric layer and an intermediate “hard” second polymeric layer.

FIGS. 3C and 3D show exemplary cross-sectional side views of composite materials formed as an asymmetric four-layer composite and a symmetric four-layer composite.

FIG. 4 shows an example of force decay where a composite material may be annealed at 65 degrees C. over a specified treatment time.

FIG. 5 shows an example where multiple polymeric layers may be thermoformed sequentially upon the dentition mold.

FIG. 6 shows a perspective view of one example of a first polymeric layer and a third polymeric layer having a perforated or breathable polyurethane second polymeric layer in between.

FIG. 7 shows a composite polymeric material incorporating a fourth polymeric layer.

FIG. 8 shows a perspective view of yet another variation in which a two-layer composite material may be comprised of a polyurethane first layer and a polyester or co-polyester second layer.

FIGS. 9A and 9B show perspective views of yet another variation in which a first polymeric layer may be made of both “hard” and “soft” polymeric portions combined into a single layer.

FIG. 10A shows an exemplary schematic image of how the polymeric layer may exert excess displacement forces and restoring forces upon the tooth or teeth when they are turned into aligners.

FIGS. 10B to 10E show examples of different patterns that may be formed into polymeric layer such that the resulting aligner having the patterns may exert a controlled amount of force.

FIG. 11 shows polymeric layer which may be formed upon a mold to result in the formed aligner.

FIG. 12A shows an exemplary schematic image of a polymeric layer exerting displacement forces and restoring forces upon the tooth or teeth when they are turned into aligners.

FIG. 12B shows an example of the polymeric layer having a plurality of rigid materials deposited into or upon the layer to selectively rigidify the layer.

FIG. 13 shows a flow diagram of how the patterns may be calculated and configured based the treatment and desired movement.

FIG. 14 shows a top view of an example of the polymeric layers or composite materials in a flattened sheet prior to thermoforming upon a mold for forming an aligner with a vector force field of the desired forces to be imparted from the to-be-formed aligner mapped upon the composite material.

FIG. 15 shows clear areas upon the flattened material which correlate primarily to the buccal incisor area and hidden areas which correlate primarily to the lingual and posterior areas of the to-be-formed aligner.

FIG. 16 shows a flow diagram for one variation of a selection process when mapping a vector field onto a composite material but with using a best matching sheet or layer.

FIG. 17 shows another variation of a polymeric composite material with the defined region of a to-be-formed aligner having an integrated feature.

FIG. 18 shows a perspective assembly view of one configuration where an outer layer may comprise an airtight layer and an inner layer may comprise a patterned layer which is an air permeable layer.

FIGS. 19A and 19B show perspective views of an exemplary mold defining one or more openings at selected regions and the corresponding aligner formed to have protrusions where formed over the openings.

### DETAILED DESCRIPTION OF THE INVENTION

When treating a patient in correcting malocclusions in their dentition, particularly with aligners placed upon the teeth, it is generally desirable to apply a consistent force upon the tooth or teeth to be moved over time without the applied force decaying over the period of treatment while the patient uses the aligner. Hence, the practitioner will attempt to optimize the amount of applied force given the stage of treatment upon the teeth.

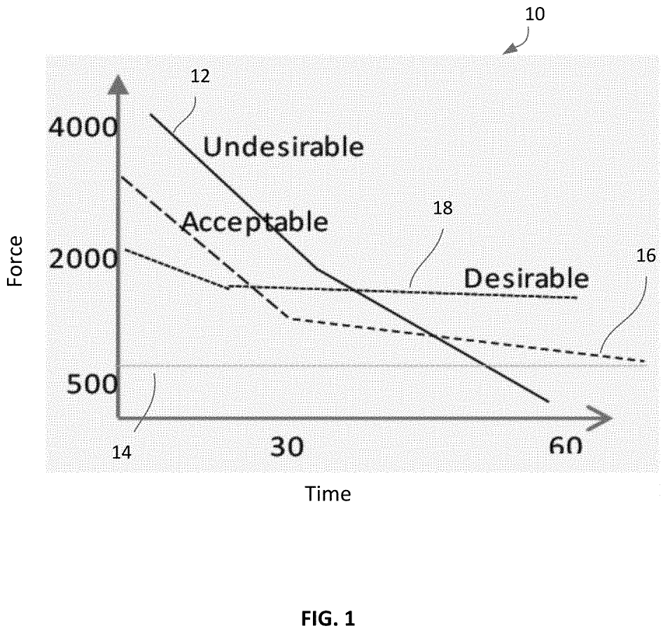

As shown in the graph 10 of FIG. 1, various performance characteristics are shown of different aligner types. An aligner which has generally undesirable characteristics is shown in plot 12 where the aligner presents a relatively high initial force, e.g., 4000 grams (measured on plastic films used for thermoforming aligners, e.g. prior to thermoforming, considering standardized test methods such as ASTM 2990-01 and the like, it should not be construed as stress forces directly applied onto individual tooth and measured, it is likely that the thickness of the aligner and the force values will change post-thermoforming, how the force profile trends persist post-thermoforming may be depend on the nature of material and the conditions used), applied against the patient's teeth but where the application force drops rapidly over a treatment period of time, e.g., 60 hours. Such a high initial force may be uncomfortable for the patient and the rapid drop of the force may leave the aligner loose upon the patient's teeth near the end of the treatment period shown. Another aligner which may present a relatively lower initial force, e.g., 500-700 grams, but which applies the lower force over the length of the treatment period is shown in plot 14 which may present an aligner with greater comfort to the patient but which is ineffective at moving teeth.

Yet another plot 16 which is generally acceptable for treatment purposes is shown having a relatively lower application force, e.g., greater than 3000 grams, but which drops over time to a second lower level, e.g., greater than 1000 grams, but which remains at a relatively consistent level. Finally, a plot 18 having desirable aligner characteristics is shown where an initial force applied, e.g., greater than 2000 grams, may drop over the period of time to a second lower level, e.g., below 2000 grams, but which maintains a consistently higher application of force over the entire length of the treatment. Of course, an ideal scenario could be that an aligner sheet that maintains a consistent force of, e.g., 1000 grams or 1200 grams, from the begin to end without any change in the stress force. The force values mentioned here are exemplary to communicate how a consistent force may be applied over a period of time without stress decay and should not be construed as the actual forces applied by a thermoformed aligner onto teeth. Aligner thickness, thermoforming conditions, applied strain and several other factors may impact the actual force experienced by tooth/teeth.

Many conventional aligners may resemble the profiles of 12 or 16, or in between, but they offer a single stress force profile throughout the treatment, despite the fact that patient requires customizable forces for different stages of treatment. Also, significant drop in stress forces or dynamic variation in stress forces over treatment period leads to a disconnect between the tooth movement prediction from modeling and actual tooth movement accomplished in patients.

The materials disclosed may be utilized for orthodontic aligners which apply a relatively lower initial force and provide for improved stress relaxation properties. In one variation, such an aligner fabricated from the materials may impart a force of, e.g., 100-4000 grams (measured on raw plastic sheets under simulated strain conditions in the lab to measure stress retention), during a treatment over a period of, e.g., 4-5 days. Such a force profile may provide for patient comfort and efficient tooth movement. These values are presented as exemplary values and the actual amount of force imparted by a thermoformed aligner may vary from the values presented. Furthermore, such an aligner may be customizable to provide any number of force profiles for tooth movement according to individual patient treatments, as described in further detail herein. Additionally, such aligners may be fabricated from using any safe medical grade or biodegradable resins such as polyesters, co-polyesters, polyamides, polyurethanes, polycarbonates, polyolefin, polypropylenes, polyethylenes, polyacrylic, polylactic, polycaprolactone, polyhydroxyalkanoate, polybutylene succinate, starch based, polysaccharides, silicones, and innumerable others resins and their combinations known to those skilled in the art. Moreover, such an aligner may be direct 3D printed or thermoformed within an orthodontic office locally.

With treatment planning software utilizing aligners or other orthodontic devices, particular treatment planning processes and orthodontic aligners which may be used in any combination with the methods and materials described herein are described in further detail in U.S. Pat. Nos. 10,624,717; 10,335,250; 10,631,953; 10,357,336; 10,357,342; 10,588,723; 10,548,690, as well as U.S. Pat. Pubs. 2017/0100208; 2019/0321135; 2020/0205936; 2019/0343602; 2020/0170762; 2018/0078343; 2018/0078344; 2018/0078335; 2020/0146775. The details of these references are incorporated herein by reference in their entirety and for any purpose.

One variation of a combination of polymer materials applied in a predetermined layered configuration may include a first polymeric layer such as a thermoplastic polyester and a second polymeric layer layered upon the first polymeric layer and a third polymeric layer such as a thermoplastic polyester layered upon the second polymeric layer such that the second polymeric layer is layered between the first and third polymeric layers. The first and third polymeric layers may be the same or similar material.

Another variation may utilize a combination of a first polymeric layer of a thermoplastic polyester, a second polymeric layer of a thermoplastic polyurethane, and a third polymeric layer of a thermoplastic polyester where the first and third polymeric layers may be the same or similar material. The respective combination of polymers in their layered configuration may yield a force decay over time which remains at a relatively higher initial level and remains at a higher level over the decay period.

Another variation may include a first polymeric layer such as a thermoplastic polyester, a second polymeric layer of an aromatic thermoplastic polyurethane, and a third polymeric layer such as a thermoplastic polyester.

Yet another variation may include a four-layer polymeric composite which is asymmetrically layered with a hard-soft-hard-soft polymeric arrangement. The hard layers may be comprised of a thermoset polyester or co-polyester polymer such as Isoplast® 2530 (Lubrizol Advanced Materials, Inc., Ohio), Eastar™ 6763, MP100, Tritan™ MX810, Tritan™ MX711 (Eastman Chemical Company, Tennessee), etc. while the soft layers may be comprised of a thermoplastic elastomer such as thermoplastic polyurethane such as Pellethane 2363 series of materials (Lubrizol Advanced Materials, Inc., Ohio), Isothane 5075D, Isothane 5095A (Great Eastern Resins Industrial Co. Ltd., Taiwan), etc. The resulting polymeric composite is one having an optical clarity when thermoformed into the orthodontic appliance and which is stain resistant against various liquids of food such as coffee, wine, etc.

Furthermore, the polymeric composite is neither too rigid nor too flexible. If the composite is too rigid, the resulting orthodontic appliance may cause discomfort or harm to the patient but if the composite is too flexible, the resulting orthodontic appliance may not exert enough force on the teeth to achieve targeted teeth movement. Over time, some of the aligner may become ineffective due to stress relaxation (e.g., due to loss of stress forces under constant strain or creep) and may not achieve the objective of moving teeth. Therefore, exerting an optimal amount of force and sustaining the force over a stipulated period (typically two weeks or more) is ideal for tooth movement. Hence, multi-layer polymeric films can be adjusted by manipulation of hard polymers and soft polymers to optimize the stress force and relaxation properties of the resulting aligners formed with the composite polymeric films. The soft layer in any multi-layer may not play a significant role in determining the ultimate stress retention force over a period of time. Instead, it is possible that the soft layer may lower the initial force or improve the comfort factor by altering the flexibility and conformability or modulus of the composite.

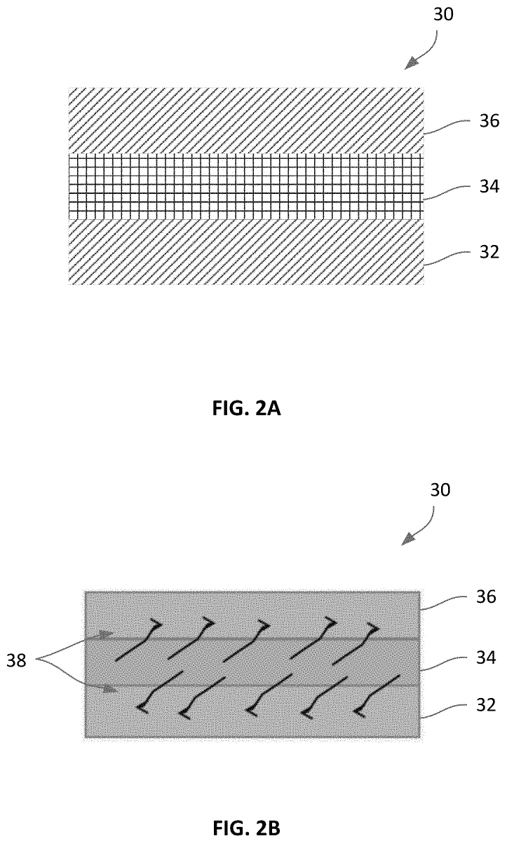

FIG. 2A illustrates an exemplary cross-sectional side view to illustrate how the various layers may be configured relative to one another so that the composite mechanical properties provide the desired optimal force decay by an aligner fabricated from such a composite material over time. As shown, a first polymeric layer 32 may have a second porous or perforated polymeric layer 34 layered upon the first polymeric layer 32 and a third polymeric layer 36 may be layered upon the second porous or perforated polymeric layer 34 such that this second layer 34 is sandwiched between the first polymeric layer 32 and the third polymeric layer 36. The overall composite material 30 formed may provide the desirable force.

While the specific materials used for each layer may comprise the materials described above, the material properties of each layer may be generalized as “hard” layers. For example, polymeric materials which are generally considered to be “soft” may have a flexural modulus ranging from, e.g., 50-500 MPa, while polymeric materials which are generally considered to be “hard” may have a flexural module ranging from, e.g., 1000-2500 MPa. Hence, the various layers may be provided in a number of different configurations to provide a resultant composite material which may be used to thermoform an aligner. One variation may utilize a combination of layers where each layer is considered to be a “hard” polymer so that the first polymeric layer 32 may have a flexural modulus of, e.g., 1600-2100 MPa, the second polymeric layer 34 may have a flexural modulus of, e.g., 1360 MPa, and the third polymeric layer 36 may have a flexural modulus of, e.g., 1600-2000 MPa. In this variation, the first 32 and third polymeric layers 36 may have a first flexural modulus which is equivalent to one another while the second polymer layer 34 which is positioned between the first 32 and third polymeric layers 36 may be considered as a “hard” polymer but it may have a second flexural modulus which is less than the first flexural modulus.

The first polymeric layer 32 and the third polymeric layer 36 may both be comprised of thermoplastic polyester or co-polyester or polyurethane while the second polymeric layer 34 may be comprised of a perforated soft or hard polymeric material. Having perforated polymeric material facilitates the stabilization of the entire composite structure and may prevents or inhibits the force decay over time due to the limited diffusion 38 of the polyester or polyurethane from the layers 36 and 32 into 34 or vice versa, as illustrated in the cross-sectional schematic view of FIG. 2B, and may also prevent the polymer chains from relaxing further. Such a combination of layers form the composite material 30 having at least one elastic layer with elongation at break of over 150% or preferably 250% and the elongate at yield is over 5% or preferably 6%.

With the various polymeric materials and the variety of combinations available, the aligners formed for patient treatment may be tuned or customized. For example, a first aligner fabricated from a first composite material to apply a first force response (e.g., relatively high force response), and a second or subsequent aligner fabricated from a second composite material to apply a second force response (e.g., relatively lower force response than the first force response). The use of different force response decay profiles may allow for the user to balance patient comfort against the moment force applied by the aligner such that a relatively higher force may be applied early but which decays relatively quickly. Typically, the percentage of material that contributes to high force response in an aligner material may be higher than 50%, preferably higher than 60%, even more preferably higher than 65%.

Another example may include the user of a first aligner fabricated from a first composite to impart a relatively higher initial force of, e.g., 1200 grams to 3500 grams (measured using plastic film before thermo-formation of aligner according to ASTM standards), for a first treatment period of, e.g., first 4 weeks. A second aligner fabricated from a second composite may be used to impart a moderate force of, e.g., 700 to 1500 grams, and a third or subsequent aligner may be fabricated from a third composite material to impart a relatively low consistent force of, e.g., 100 to 700 grams, over the course of a treatment.

Any variety of treatment options and force response levels may be used in different combinations depending upon the materials used for fabricating the aligners.

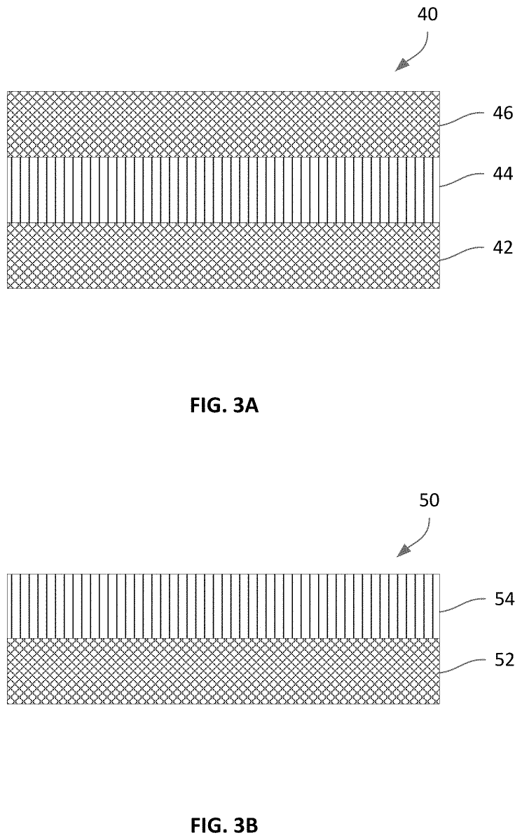

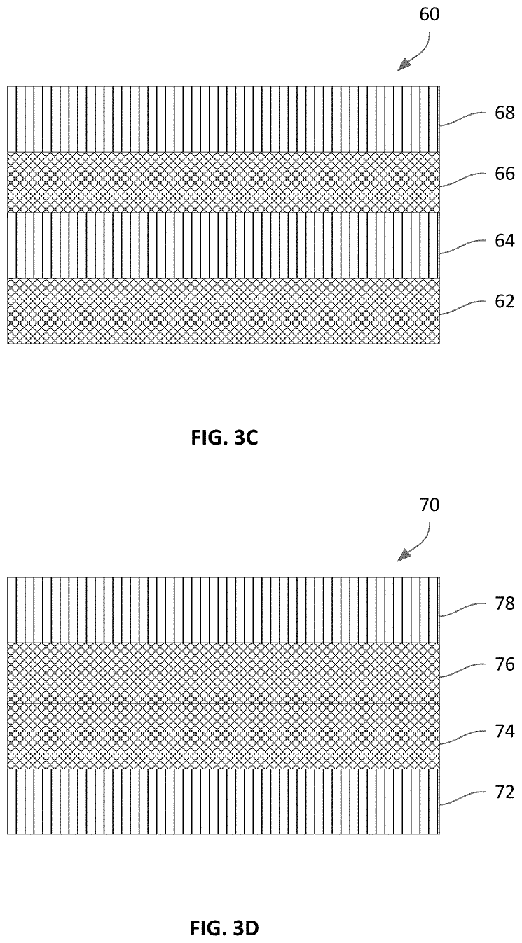

FIG. 3A illustrates schematically a composite material 40 formed to have a “hard” first polymeric layer 42 and a “hard” third polymeric layer 46 each with a flexural modulus of, e.g., at least 2000 MPa or 2000 MPa (250 Microns), and an intermediate “hard” second polymeric layer 44 with a flexural modulus of, e.g., at least 1360 MPa or 1360 MPa (250 Microns), as previously described. The following Table 1 shows a summary of the three-layer composite embodiment.

TABLE 1
Three-layer composite.

| Layer | Flexural Modulus (MPa) | Thickness (Micron) |
|---|---|---|
| 3 | 2000 | 250 |
| 2 | 1360 | 250 |
| 1 | 2000 | 250 |

However, an alternative variation may include a two-layer composite material 50, as illustrated in the cross-sectional side view of FIG. 3B. In the two-layer embodiment, a “hard” first polymeric layer 52 may have a first flexural modulus of, e.g., 600-1400 MPa, and a “hard” second polymeric layer 54 may have a second flexural modulus of, e.g., 1400-2100 MPa, which may be considered “hard” but where the first flexural modulus is less than the second flexural modulus. The following Table 2 summarizes one variation of the two-layer composite embodiment. However, if the composition of polymer with modulus higher than 1400 is above 80%, the layer is second layer modulus is over less relevance in terms of stress retention.

TABLE 2
Two-layer composite.

| Layer | Flexural Modulus (MPa) | Thickness (Micron) |
|---|---|---|
| 2 | 1400-2100 | 250 |
| 1 | 600-1400 | 250 |

In yet another variation of the two-layer embodiment of FIG. 3B, the “hard” first polymeric layer 52 may instead have a first flexural modulus of, e.g., 1000-2500 MPa, and having a thickness which may range from 460-760 micron (about 18-30 mil), and a “soft” second polymeric layer 54 having a second flexural modulus of, e.g., 50-1000 MPa and having a thickness which may range from 50-250 micron (about 2-10 mil).

The first polymeric layer 52 may be comprised of a polyester or co-polyester material having a yield stress greater than 5% and which also exhibits good stress retention pre-thermoforming and post-thermoforming such that the first polymeric layer 52 contributes at least 60% of the total layer thickness and at least 70% of the total stress force for moving the teeth. The second polymeric layer 54 may be comprised of an elastomer which has a breaking failure point which is 300% higher than the yield stress and with a flexural modulus of less than 100 MPa. The overall stress retention drop post-thermoforming may be less than 30%, or less than 20%, or less than 10%.

The following Table 3 summarizes another variation of the two-layer composite embodiment.

TABLE 3
Two-layer composite.

| Layer | Flexural Modulus (MPa) | Thickness (Micron) |
|---|---|---|
| 2 | 50-1000 | 50-250 |
| 1 | 1000-2500 | 460-760 |

In either the three-layer composite material 40 or the two-layer composite material 50, the polymers used may be varied so long as the flexural modulus values remain within the prescribed ranges.

In one variation of the three-layer composite 40, the first 42 and third 46 layers having a flexural modulus of 2000 MPa having a flexural modulus of 1500 MPa. In the two-layer composite 50, the second layer 54 may be comprised of either polymeric material.

Similarly, for the three-layer composite 40 for the second layer 44 and for the two-layer composite 50 for the first layer 52 having a flexural modulus of 1360 MPa or other alternative polyurethanes having a flexural modulus greater than 500 MPa.

In yet another variation, an asymmetrical arrangement of multiple layers may be formed as illustrated in the four-layer composite 60 to have a hard-soft-hard-soft layer arrangement as illustrated in the cross-sectional side view of FIG. 3C. Here, hard and soft layers may be interspersed with one another where a first hard layer 62 may have a flexural modulus ranging between 1000-2500 MPa with a thickness of 130-305 micron (about 5-12 mil). A second soft layer 64 may be positioned adjacent to the first hard layer 62 and have a flexural modulus ranging between 50-1200 MPa with a thickness of 25-250 micron (about 1-10 mil). A third hard layer 66 may be positioned upon the second soft layer 64 opposite to the first hard layer 62 and have a flexural modulus ranging between 1000-2500 MPa with a thickness of 130-305 micron (about 5-12 mil). A final fourth soft layer 68 may be positioned upon the third hard layer 66 with a flexural modulus ranging between 50-1200 MPa with a thickness of 25-250 micron (about 1-10 mil). The resulting composite 60 may have a hard-soft-hard-soft layer arrangement where the fourth soft layer 68 may be configured in the resulting orthodontic appliance (e.g., aligner shell) to be placed against the surfaces of the teeth.

The fourth soft layer 68 of the composite 60 may function as a contact layer which is able to conform well against the uneven surfaces of the underlying teeth. The third hard layer 66 positioned upon the fourth layer 68 may compress against the fourth layer 68 to further conform the contact layer against the surfaces of the teeth. The second soft layer 64 which is positioned between the third hard layer 66 and first hard layer 62 may function as a buffer layer which stores energy from the two hard layers 62, 66 due to the shear forces applied initially when the aligner is placed upon the teeth. The second soft layer 64 may subsequently release the stored energy to further compress the soft fourth layer 68 against the surfaces of the teeth. The first hard layer 62 may function as a force layer which provides force for moving the teeth. It may also present a smooth surface for contact against other soft tissues within the mouth such as the tongue and may also present a surface which is easy for the patient to clean in-between uses.

As described above, the outer first polymeric layer 62 may be comprised of a polyester or co-polyester material having a yield stress greater than 5% and which also exhibits good stress retention pre-thermoforming and post-thermoforming such that the first polymeric layer 62 may contribute at least 60% of the total layer thickness and 70% of the total stress force for moving the teeth. The outer fourth polymeric layer 68 may be comprised of an elastomer which has a breaking failure point which is 300% higher than the yield stress and with a flexural modulus of less than 100 MPa. The overall stress retention drop post-thermoforming may be less than 50%, or less than 20%, or less than 10% (when constant strain applied is below 5%). The total thickness of the composite may accordingly range from 310 to 1110 microns.

The following Table 4 summarizes one variation of the asymmetric four-layer composite embodiment.

TABLE 4
Asymmetric four-layer composite.

| Layer | Flexural Modulus (MPa) | Thickness (Micron) |
|---|---|---|
| 4 | 50-1200 | 25-250 |
| 3 | 1000-2500 | 130-305 |
| 2 | 50-1200 | 25-250 |
| 1 | 1000-2500 | 130-305 |

In yet another variation, a four-layer composite 70 may be formed with a soft-hard-hard-soft polymer layer arrangement, as illustrated in the cross-sectional side view example of FIG. 3D. The first soft layer 72 may have a flexural modulus of 150 MPa with a thickness of 100 micron, the second hard layer 74 adjacent to the first layer 72 may have a flexural modulus of 1500 MPa with a thickness of 250 micron, the third hard layer 76 may be formed upon the second layer 74 opposite to the first layer 72 and have a flexural modulus of 1500 MPa with a thickness of 250 micron, and the fourth soft layer 78 may be formed upon the third layer 76 opposite to the second layer 74 and have a flexural modulus of 150 MPa with a thickness of 100 micron. The first soft layer 72 and fourth soft layer 78 may each be formed of an elastomeric material having a hardness value of A95 and the second hard layer 74 and third hard layer 76 may each be formed of a co-polyester having a hardness value of R120. With each of the layers formed into the composite 70, the overall composite flexural modulus may be 725 MPa+/−100 MPa. Because of the symmetric configuration, either of the first soft layer 72 or fourth soft layer 78 may be formed for direct placement against the teeth of the patient. The following Table 5 summarizes the variation of the four-layer composite embodiment.

TABLE 5
Four-layer composite.

| Layer | Flexural Modulus (MPa) | Thickness (Micron) |
|---|---|---|
| 4 | 150 | 100 |
| 3 | 1500 | 250 |
| 2 | 1500 | 250 |
| 1 | 150 | 100 |

In yet another alternative variation, the four-layer composite 70 may be formed with a soft-hard-hard-soft polymer layer arrangement, similarly as described above. Yet this variation may have the first soft layer 72 and/or fourth soft layer 78 (e.g., both soft layers 72 and 78 or one of the soft layers 72 or 78) be formed to have a compression set to be greater than 40% after 24 hours at 70 degrees C. Additionally, and/or alternatively, the second hard layer 74 and/or third hard layer 76 (e.g., both hard layers 74 and 76 or one of the hard layers 74 or 76) may be formed to have a tensile strength at yield to be, e.g., between 4000 psi and 6500 psi. Hence, the composite 70 may be formed with none, one, or both soft layers 72, 78 to have its layer compression set to be greater than 40% after 24 hours at 70 degrees C. and/or none, one, or both hard layers 74, 76 to have a tensile strength at yield to be, e.g., between 20 MPa and 50 MPa, preferably between 25 to 45 MPa. The following Table 6 summarizes the variation of the four-layer composite embodiment which is similar to the variation above.

TABLE 6
Four-layer composite.

| Layer | Flexural Modulus (MPa) | Thickness (Micron) |
|---|---|---|
| 4 | 150 | 100 |
| 3 | 1500 | 250 |
| 2 | 1500 | 250 |
| 1 | 150 | 100 |

In yet another alternative variation, the four-layer composite 70 may be formed with a soft-hard-hard-soft polymer layer arrangement, similarly as described above. Yet this variation may have the first soft layer 72 and/or fourth soft layer 78 (e.g., both soft layers 72 and 78 or one of the soft layers 72 or 78) be formed to have a thickness of greater than 100 micron so that the overall composite 70 thickness is greater than 700 micron. The following Table 7 summarizes the variation of the four-layer composite embodiment.

TABLE 7
Four-layer composite.

| Layer | Flexural Modulus (MPa) | Thickness (Micron) |
|---|---|---|
| 4 | 150 | >100 |
| 3 | 1500 | 250 |
| 2 | 1500 | 250 |
| 1 | 150 | >100 |

In yet another alternative variation, the four-layer composite 70 may be formed with a soft-hard-hard-soft polymer layer arrangement, similarly as described above. Yet this variation may have the second hard layer 74 and/or third hard layer 76 (e.g., both hard layers 74 and 76 or one of the hard layers 74 or 76) be formed to have a thickness of less than 200 micron so that the total composite thickness of both hard layers 74, 76 is less than 400 microns and the overall composite 70 thickness is less than 600 micron. The following Table 8 summarizes the variation of the four-layer composite embodiment.

TABLE 8
Four-layer composite.

| Layer | Flexural Modulus (MPa) | Thickness (Micron) |
|---|---|---|
| 4 | 150 | 100 |
| 3 | 1500 | <200 |
| 2 | 1500 | <200 |
| 1 | 150 | 100 |

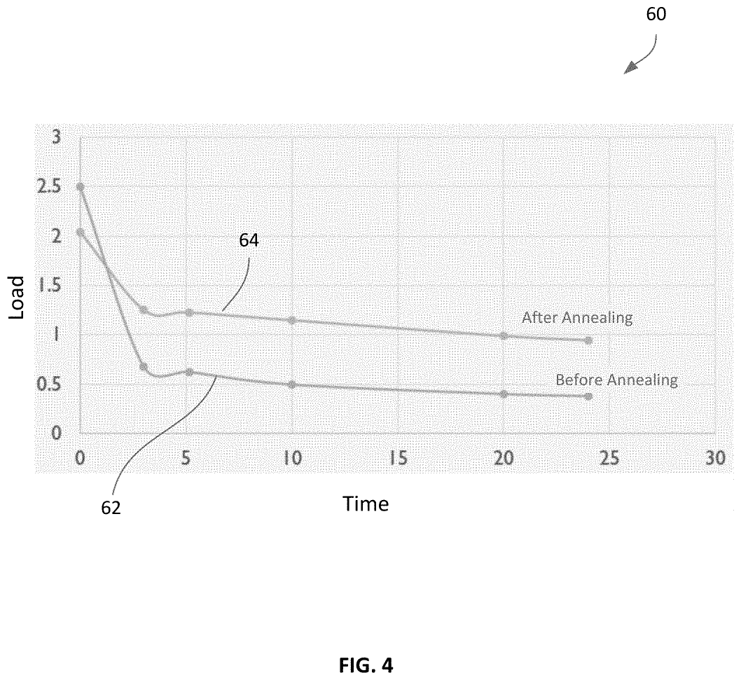

With any of the composite materials described herein, additional processing may be performed on the materials to further improve their various properties depending upon the desired results. For example, the composite material may be exposed to one or more heat treatments, for example, to improve the relative stress relaxation properties. FIG. 4 shows an example in the force decay graph 80 where a composite material may be annealed at or over 65 degrees C. over a specified treatment time. Examples of some treatment times may include, e.g., at least 15 hours or 20 hours. In other variations, the material may be annealed at or over 80 degrees C. over a minimum treatment time of, e.g., 15 hours. The resulting force decay profile 82 of an untreated sample relative to the force decay profile 84 of an annealed sample illustrates how the annealed sample may provide an initial force which is lower than the untreated sample but the response force overtime remains at a relatively higher level over time. Such a heat treatment process may be applied to any of the composite materials described herein with varying composition of layers or thicknesses to alter the mechanical properties accordingly.

Aside from heat treatment, the process by which an aligner is thermoformed may also be altered. For a three-layer composite material (or for a two-layer composite), each of the layers may be thermoformed upon a mold of the patient's dentition separately from one another rather than as a multi-layer composite sheet which is thermoformed in a single step. FIG. 5 illustrates an example where a first polymeric layer 92 may be initially thermoformed upon the dentition mold 90. Once the first polymeric layer 92 has been deposited and formed, the second polymeric layer 94 may be subsequently deposited and formed upon the first polymeric layer 92 and the third polymeric layer 96 may be subsequently deposited and formed upon the second polymeric layer 94 to form the final multi-layer composite aligner.

As with heat treatment processing, the process of applying individual polymeric layers may be utilized for any of the composite materials described herein.

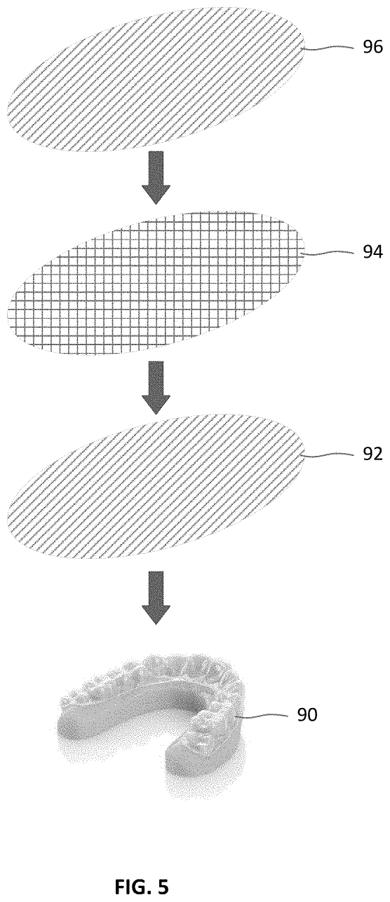

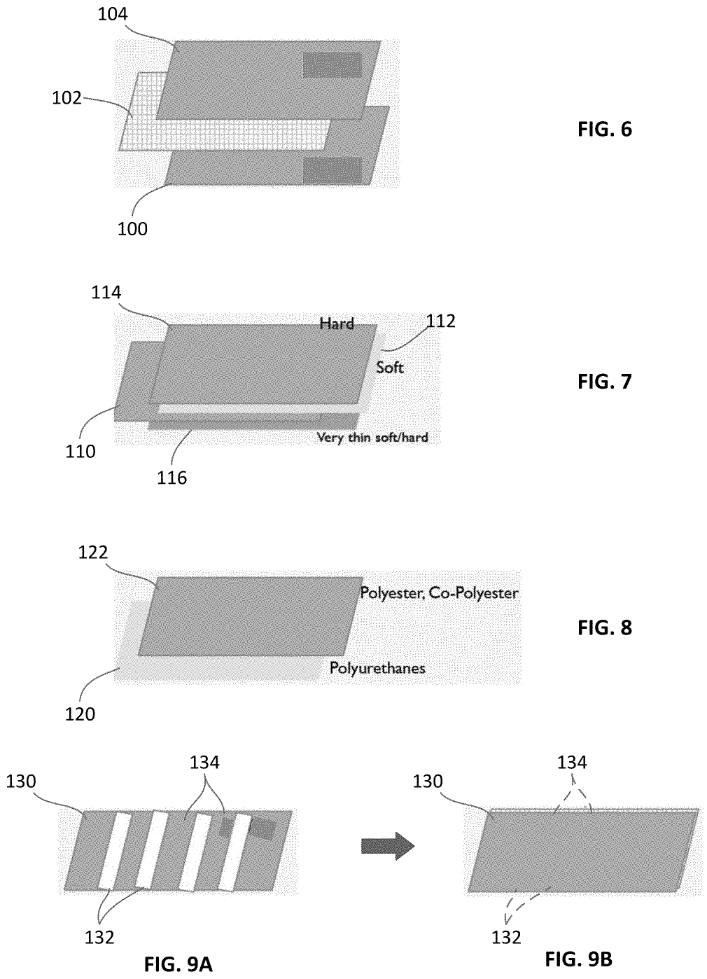

In yet another variation, one or more layers of the composite material may be perforated or otherwise incorporate one or more openings through the entire layer or just portions of the layer. FIG. 6 shows a perspective view of one example of a first polymeric layer 100 and a third polymeric layer 104 having a perforated or breathable polyurethane second polymeric layer 102 in between. The size, shape, and pattern of the openings may be varied depending upon the desired results and further enables the first and third polymeric layers 100, 104 to flow into and through the pores may provide for enhanced stress relaxation of the composite material, and control over displacement and restoring forces. Additionally, one or more agents such as anti-microbial agents may be incorporated into the second polymeric layer 102. Furthermore, any or all of the individual layers may be fabricated from a bio-degradable polymer.

Yet another variation may incorporate the addition of a fourth polymeric layer, as shown in the perspective view of FIG. 7, which shows a first 110 and third 114 polymeric layer made from a “hard” polymer while the second polymeric layer 92 may be made of a “soft” polymer. A fourth polymeric layer 116 made of a “soft” or “hard” polymer may be applied either upon the first polymeric layer 110 or upon the third polymeric layer 114 again depending upon the desired results.

FIG. 8 shows a perspective view of yet another variation in which a two-layer composite material may be comprised of a polyurethane first layer 120 and a polyester or co-polyester second layer 122.

FIGS. 9A and 9B show perspective views of yet another variation in which a first polymeric layer 130 may be made of both “hard” and “soft” polymeric portions combined into a single layer. As illustrated in FIG. 9A, “soft” polymeric layers or portions 132 may be filled into the openings of hard polymers, resulting in a single layer with “hard” polymer layers or portions 134 so that the combination of polymers may be adjoined to one another to form a singular layer 130, as illustrated in FIG. 9B.

Any of the variations and embodiments described above with respect to FIGS. 6 to 9 may be utilized for any of the composite materials described herein.

With respect to the combination of materials in forming the composite, any or all of the individual layers may also be optionally patterned with various perforations, pores, openings, slits, indentations, etc. in a number of different configurations to further alter certain mechanical properties of the overall resulting aligner formed from the composite materials. Because the orthodontic polymeric aligner shells are used to apply translational and/or rotational forces upon teeth to move them, the polymeric materials used in fabricating the aligners should ideally exhibit a tuned, predetermined level of mechanical properties, such as elasticity, stress relaxation, resistance to creep, etc. for exerting force upon the teeth to achieve desired results.

For example, application of an excessive amount of force upon the teeth may cause patient discomfort or may cause damage to their teeth. On the other hand, applying a reduced amount of force may not sufficiently move the teeth/tooth to their desired position. Also, teeth at different locations may need to experience different levels of forces to move them into desired location. Hence, in addition to the use of different polymeric layers as described herein, any or all of the polymeric sheet materials may be formed with features such as perforations, pores, openings, slits, indentations, etc. in a variety of patterns in such a way that the patterns offer a good balance of flexibility, elasticity, impact resistance, and displacement and restoration forces. Such features may be defined over the entire polymeric layer or layers or they may be localized at predetermined areas of the polymeric layer such that these features are exhibited at preselected portions of the aligner ultimately formed from the layers. For instance, the patterns formed on the polymer layers may be positioned at selective locations in such a way that different amounts of force may be selectively applied to different teeth to customize the aligner for not only each patient, but for each tooth. The gaps in the patterned dental aligners may be optionally overcoated with a material such as a thin plastic material or alternatively filled with an elastic material to prevent accumulation of unwanted particles, biomass, or discoloration while in use. The patterns can also be applied at different thicknesses, for example, a thinner layer of material may be needed at an occlusal surface of the aligner but a thicker layer of material may be positioned near the gum regions to exert required forces.

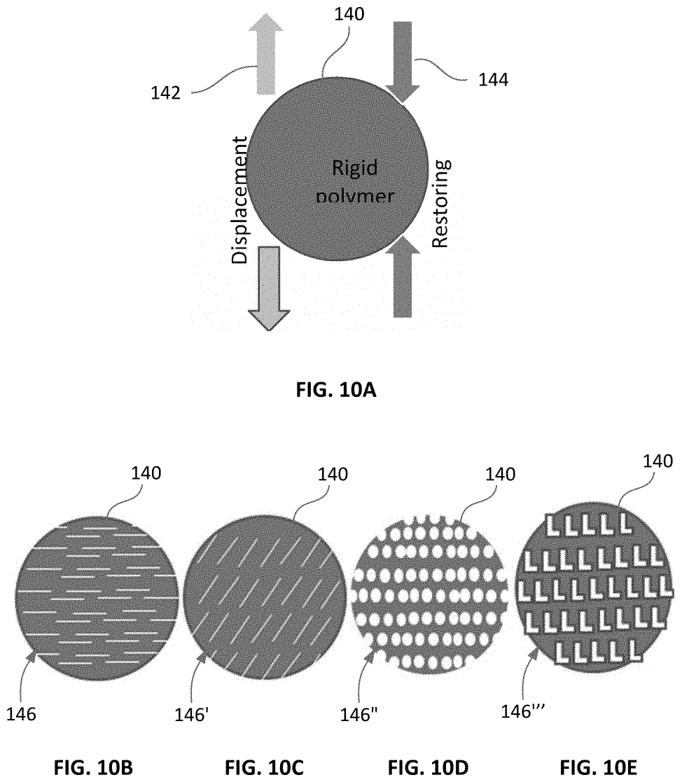

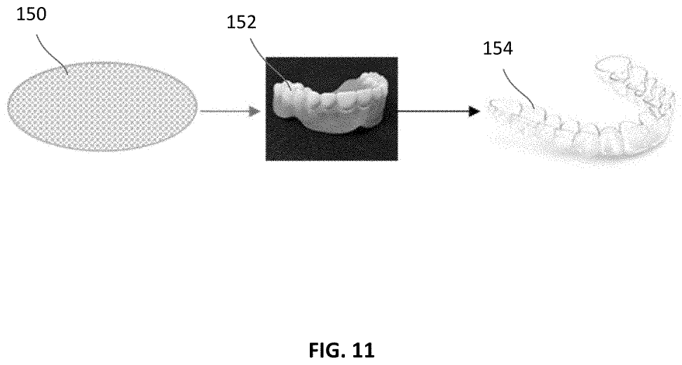

As shown in the exemplary schematic image of FIG. 10A, the polymeric layer 140 may exert excess displacement forces 142 and restoring forces 144 upon the tooth or teeth when they are turned into aligners, as illustrated by the polymeric layer 150 which may be formed upon a mold 152 to result in the formed aligner 154, illustrated in FIG. 11. These displacement forces 142 and restoring forces 144 imparted by the aligner can be controlled in such a way to reduce discomfort to the patient and to also control the resulting forces imparted by the aligner upon the teeth or tooth. FIGS. 10B to 10E illustrate examples of different patterns that may be formed into polymeric layer 140 such that the resulting aligner having the patterns may exert a controlled amount of force, for instance, a controlled translational and/or rotational force for each patient and for each tooth or teeth.

FIG. 10B shows an example of a pattern of slits 146 formed into the layer 140 while FIG. 10C shows an example of slits 146′ which may be angled relative to the formed aligner. FIG. 10D shows an example of openings or pores 146″ while FIG. 10E shows an example of “L” shaped openings 146″. Such patterns are shown as examples of the various types of patterns that may be formed upon the polymeric layer 140 or portions of the layer 140 for formation in the aligner.

Additionally and/or alternatively, a polymeric layer may be selectively rigidified using a pattern. For example, a rigid material such as plastics, composites, metallic substrates, etc. may be deposited onto a polymeric layer in a predetermined pattern to alter the translational and rotational force they exert upon the teeth or tooth when formed into an aligner. Generally, a rigid material may have a flexural modulus above, e.g., 1000 MPa, but other materials with a flexural modulus below may also be used depending upon the desired degree or rigidity. The deposition of rigid materials could be upon selected locations to customize the force exerted on each tooth. It is also possible to deposit the rigid materials using a 3D printing technique or extrusion or any other known methods.

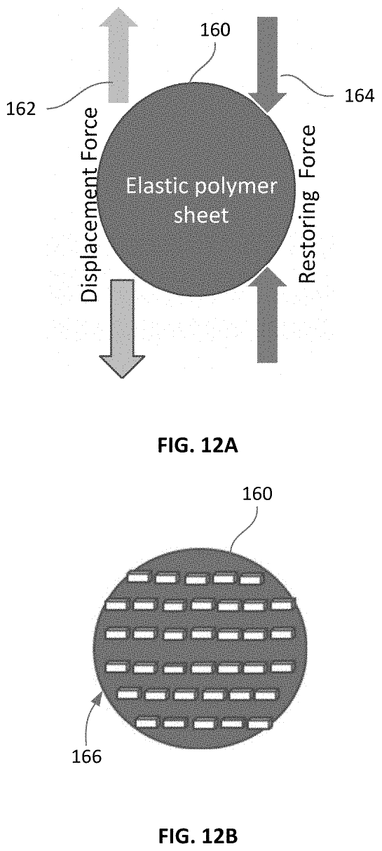

FIG. 12A illustrates an exemplary schematic image of a polymeric layer 160 exerting displacement forces 162 and restoring forces 164 upon the tooth or teeth when they are turned into aligners. FIG. 12B illustrates an example of the polymeric layer 160 having a plurality of rigid materials 166 deposited into or upon the layer 160 to selectively rigidify the layer 160. The deposited materials (e.g., rigid polymer, composites, metals, ceramics, etc.) may have a relatively higher modulus to modify the translational and/or rotational forces exerted by the aligners. An overcoat may also be laid over the deposited materials 166, if desired. Although, one pattern is illustrated, the deposited rigid materials may be laid or positioned in any pattern or configuration to achieve a desired translational, rotational, displacement and/or restoration forces that in a customized manner.

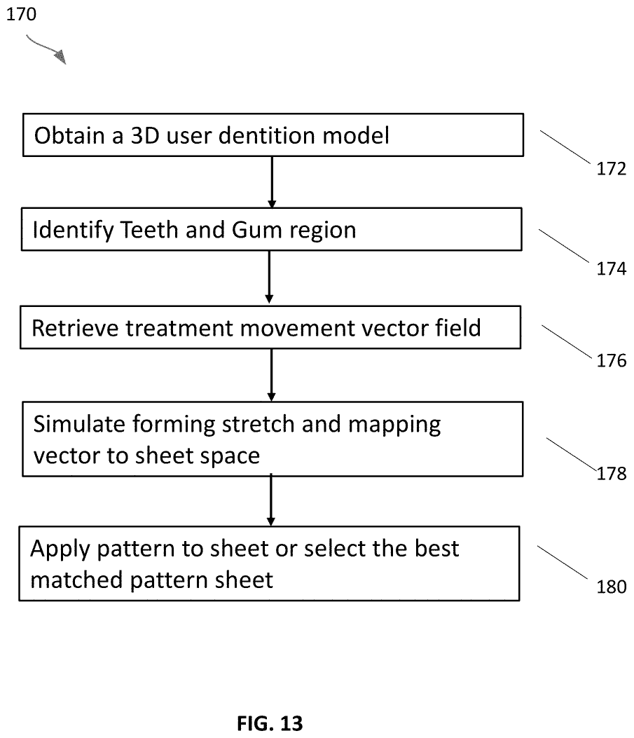

FIG. 13 illustrates a flow diagram 170 of how the patterns may be calculated and configured based the treatment and desired movement. As shown, a 3D model of the patient's dentition to be corrected may be received or otherwise obtained 172 and the regions of teeth and gums may be identified 174 utilizing any of the methods and processes disclosed in any of the incorporated references. The vector fields associated with movement of the teeth 176 by an aligner may be retrieved or otherwise identified and the stretch of the aligners may be simulated and the vector fields mapped to a sheet space 178 which is initially planar. A pattern to be applied to the polymeric layer may be determined or a template pattern sheet may be matched as a best fit 180 to the vector fields. Once the mapped vector fields are identified, a suitable pattern may be applied upon the region of the layer which correlates with the desired forces to be imparted by the aligner once the layer has been formed into its final aligner shape.

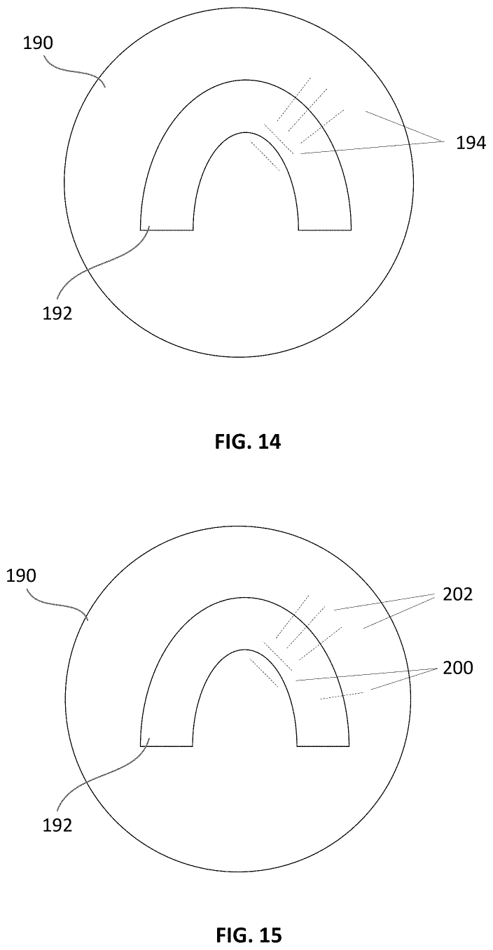

FIG. 14 shows a top view of an example of any of the polymeric layers or composite materials 190 described herein in a flattened sheet prior to thermoforming upon a mold for forming an aligner. The region 192 illustrates the portion of the polymeric composite material 190 which correlates to where the composite material 190 will be placed upon the mold for forming the aligner. The vector force field with the desired forces to be imparted from the to-be-formed aligner is shown mapped upon the composite material 190 and particularly around the region 192 in a corresponding pattern layout 194. It is along this pattern layout 194 that any of the patterns may be defined or rigidizing materials may be incorporated depending upon the desired forces to be applied or enhanced.

FIG. 15 illustrates clear areas 202 upon the flattened material 190 which correlate primarily to the buccal incisor area and hidden areas 200 which correlate primarily to the lingual and posterior areas of the to-be-formed aligner. For the hidden areas 200, once the aligner has been formed, these areas are typically hidden from public view when the aligner is worn by the patient and because they remain hidden during use, alternative materials can be used along these hidden areas 200. For instance, opaque materials (non-transparent), metallic, or mesh metallic sheets, etc. can be applied as well. Common based patterned forms can be premade and a set of sheet can be selected based on best matching to the premade set.

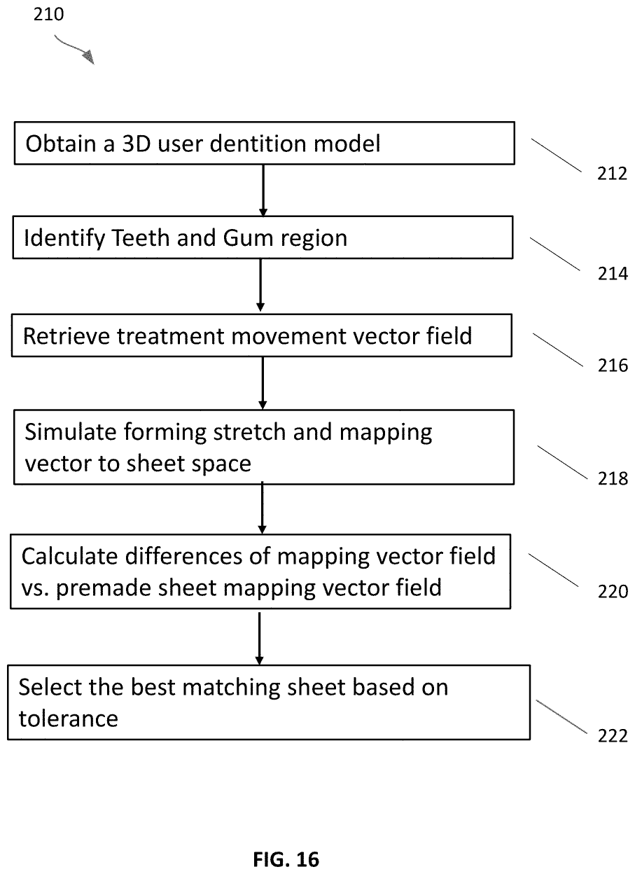

FIG. 16 illustrates a flow diagram 210 for one variation of a selection process when mapping a vector field onto a composite material, similar to the previously described process, but with using a best matching sheet or layer. As shown, a 3D model of the patient's dentition to be corrected may be received or otherwise obtained 212 and the regions of teeth and gums may be identified 214 utilizing any of the methods and processes disclosed in any of the incorporated references. The vector fields associated with movement of the teeth 216 by an aligner may be retrieved or otherwise identified and the stretch of the aligners may be simulated and the vector fields mapped to a sheet space 218 which is initially planar.

In this variation, the polymeric sheets or layers may be premade or preformed with patterns and/or rigidizing materials to have various common vector fields already mapped onto the sheets or layers to form a template. The specific vector fields for imparting the desired force upon the patient's tooth or teeth may be compared against the vector fields of the premade or preformed layers and differences between the customized vector field and the preformed vector field may be calculated 220. The premade or preformed layer which presents the minimal differences that are within acceptable tolerance limits may be selected 222 for use in forming the desired aligner.

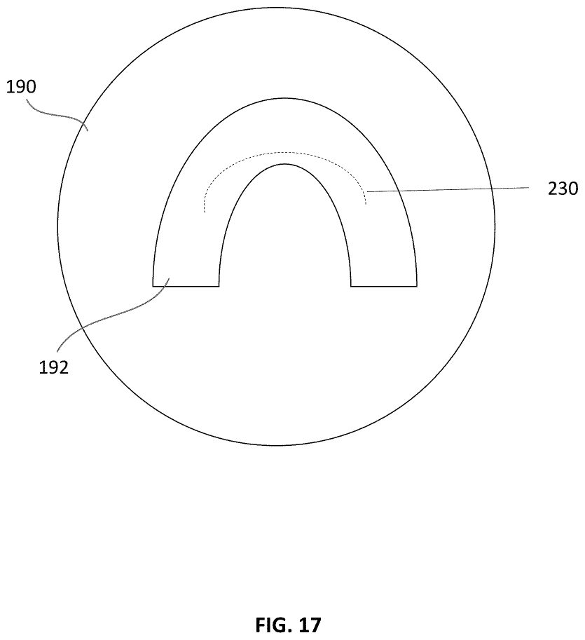

FIG. 17 shows another variation of a polymeric composite material 190 with the defined region 192 of a to-be-formed aligner having an integrated feature. In this example, a lingual bar may be integrated with the aligner to strengthen the aligner. A marked location 230 along the region 192 which corresponds to where the lingual bar is to be positioned may be calculated and marked upon the material 190, as shown. One or more wires may then be placed or integrated upon the marked location 230 according to the marker and then formed along with the sheet into the aligner. The lingual bar may have a coupled glue sheet to secure its position. While a lingual bar is shown, any other orthodontic appliance or attachment may be used in the same or similar manner for integration upon the aligner.

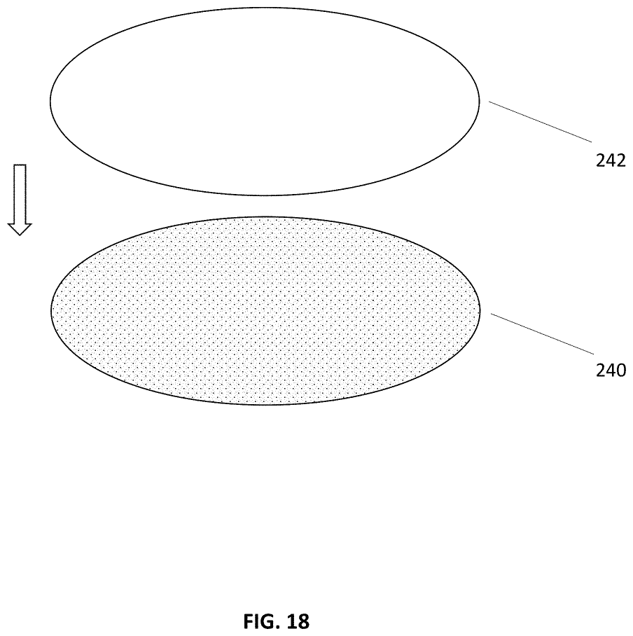

FIG. 18 illustrates a perspective assembly view of one configuration where an outer layer 242 (e.g., second polymeric layer) may comprise an airtight layer having a continuous surface and an inner layer 240 (e.g., first polymer layer) may comprise a patterned layer which is an air permeable layer. Once the layers 240, 242 are thermoformed, the layers may physically bond together without any air bubbles or moisture becoming trapped between the layers. While two separate layers are shown, more than two layers may be utilized, as described herein.

The use of permeable layers may also be used for other orthodontic applications such as the formation of indirect bonding trays where a much thicker inner layer 240 may be used to provide a housing template for brackets.

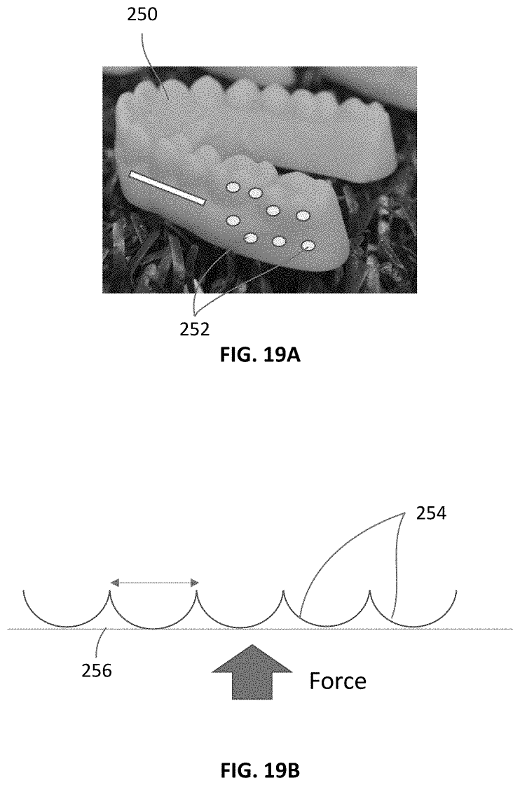

FIGS. 19A and 19B illustrate yet another variation for configuring the aligner to improve comfit and fit to the patient's dentition. The positive mold 250 which may be used to thermoform the aligner may be optionally configured to include one or more openings 252 strategically formed over different regions of the mold 250 such as along the molar region. These one or more openings 252 may be formed to have a diameter of, e.g., 1-200 microns, such that the thermoformed aligner may be formed with corresponding protrusions 254 by the polymeric materials conforming to the one or more openings 252, as shown in the cross-sectional detail view of FIG. 19B. The protrusions 254 may provide for flexibility of the aligner and comfort as well by localizing the deformations (or stress relaxation) and for allowing the aligner to grip the underlying crowns more tightly along these regions.

While different features are discussed, the assembly and processes may incorporate any number of different features into a single system in any number of combinations. A single system provided may, for example, include or incorporate every feature described herein or it may include a select number of features depending upon the desired system. Further examples include any of the multi-layer composite materials such as the two-layer, three-layer, or four-layer composite materials. Any of these variations disclosed may incorporate any or all of the other features such as perforated regions along any one or all of the various layers.

The applications of the devices and methods discussed above are not limited to the one described but may include any number of further treatment applications. Modification of the above-described assemblies and methods for carrying out the invention, combinations between different variations as practicable, and variations of aspects of the invention that are obvious to those of skill in the art are intended to be within the scope of the claims.

What is claimed is:

1. A composite material assembly, comprising:
a first polymeric layer having a first flexural modulus between 1000-2500 MPa, wherein the first polymeric layer defines a thickness of at least 460 micron;
a second polymeric layer formed upon the first polymeric layer and having a second flexural modulus different from the first flexural modulus.

2. The assembly of claim 1 wherein the assembly comprises a total thickness of between 510 to 1010 micron.

3. The assembly of claim 1 further comprising an anti-microbial agent incorporated into the assembly.

4. The assembly of claim 1 wherein the first polymeric layer defines perforations at least partially over the first polymeric layer.

5. The assembly of claim 4 wherein the second polymeric layer is formed to have a surface without any perforations.

6. The assembly of claim 1 further comprising a third polymeric layer formed upon the first polymeric layer opposite to the second polymeric layer.

7. The assembly of claim 6 wherein the third polymeric layer has a third flexural modulus different from the first flexural modulus.

8. The assembly of claim 6 further comprising a fourth polymeric layer formed upon the third polymer layer and having a fourth flexural modulus similar to the second flexural modulus.

9. The assembly of claim 1 wherein the composite material assembly is annealed at or above 65 degrees C. over a minimum of 15 hours.

10. The assembly of claim 1 wherein the first or second polymeric layer defines a pattern over at least a portion of the layer.

11. The assembly of claim 1 wherein the first or second layer comprises a plurality of rigid materials deposited into or upon the layer to selectively rigidify the layer.

12. The assembly of claim 1 wherein the composite material assembly defines a mapped vector field applied upon a region of the composite material assembly, wherein the mapped vector field correlates with a desired force to be imparted by an aligner formed from the composite material assembly.

13. A composite material assembly, comprising:
a first polymeric layer having a first flexural modulus of at least 2000 MPa;
a second polymeric layer formed upon the first polymeric layer and having a second flexural modulus of at least 1360 MPa; and
a third polymeric layer formed upon the second polymeric layer such that the second polymeric layer is positioned between the first polymeric layer and the third polymeric layer, wherein the third polymeric layer has a third flexural modulus of at least 2000 MPa.

14. The assembly of claim 13 wherein the assembly comprises a total thickness of about 750 microns.

15. The assembly of claim 13 further comprising an anti-microbial agent incorporated into the assembly.

16. The assembly of claim 13 wherein the first polymeric layer and the third polymeric layers are comprised of a co-polyester layer.

17. The assembly of claim 16 wherein the second polymeric layer is comprised of a polyurethane layer.

18. The assembly of claim 13 wherein a thickness of the first polymeric layer is 250 microns.

19. The assembly of claim 13 wherein a thickness of the second polymeric layer is 250 microns

20. The assembly of claim 13 wherein a thickness of the third polymeric layer is 250 microns.

21. The assembly of claim 13 further comprising a fourth polymeric layer formed upon the third polymeric layer.

22. The assembly of claim 21 wherein a flexural modulus of the fourth polymeric layer is between 50-1200 MPa.

23. The assembly of claim 22 wherein a thickness of the fourth polymeric layer is 25-250 microns

24. The assembly of claim 23 wherein an overall composite flexural modulus is 725 MPa+/−100 MPa.

25. The assembly of claim 13 wherein the composite material assembly is annealed at or over 65 degrees C. over a treatment time of at least 15 hours.

26. The assembly of claim 13 further comprising a fourth polymeric layer applied either upon the first polymeric layer or upon the third polymeric layer.

27. The assembly of claim 13 wherein the first, second, or third polymeric layer defines a pattern over at least a portion of the layer.

28. The assembly of claim 13 wherein the first, second, or third polymeric layer comprises a plurality of rigid materials deposited into or upon the layer to selectively rigidify the layer.

29. The assembly of claim 13 wherein the composite material assembly defines a mapped vector field applied upon a region of the composite material assembly, wherein the mapped vector field correlates with a desired force to be imparted by an aligner formed from the composite material assembly.

30. The assembly of claim 13 wherein the composite material assembly comprises a stress force ranging from 200-4000 grams at below 5% constant strain.

31. A composite material assembly, comprising:
a first polymeric layer having at least one portion comprised of a first polymer having a first flexural modulus and at least one portion comprised of a second polymer adjoined to the first polymer and having a second flexural modulus, wherein the first polymeric layer forms a singular layer.

32. The assembly of claim 31 wherein the assembly comprises a total thickness ranging from 0.5 mm to 2.0 mm.

33. The assembly of claim 31 further comprising an anti-microbial agent incorporated into the assembly.

34. The assembly of claim 31 wherein the first polymer is comprised of a hard polymer and the second polymer is comprised of a soft polymer.

35. The assembly of claim 31 wherein the composite material assembly comprises a stress force ranging from 200-4000 grams at below 5% constant strain.

36. A composite material assembly, comprising:
a first polymeric layer having a first flexural modulus;
a second polymeric layer formed upon the first polymeric layer and having a second flexural modulus and different than the first flexural modulus;
a third polymeric layer formed upon the second polymeric layer such that the second polymeric layer is positioned between the first polymeric layer and the third polymeric layer, wherein the third polymeric layer has a third flexural modulus equivalent to the first flexural modulus; and
a fourth polymeric layer formed upon the third polymeric layer such that fourth polymeric layer is opposite to the first polymeric layer, wherein the fourth polymeric layer has a fourth flexural modulus equivalent to the second flexural modulus.

37. The assembly of claim 36 wherein any one of the polymeric layers defines perforations at least partially over.

38. The assembly of claim 36 wherein the assembly comprises a total thickness ranging from 310 to 1110 microns.

39. The assembly of claim 36 further comprising an anti-microbial agent incorporated into the assembly.

40. The assembly of claim 36 wherein the first polymeric layer and the third polymeric layers are comprised of a polyester or co-polyester layer.

41. The assembly of claim 40 wherein the second polymeric layer and fourth polymer layers are comprised of a polyurethane layer.

42. The assembly of claim 39 wherein the first flexural modulus is between 1000-2500 MPa.

43. The assembly of claim 42 wherein the second flexural modulus is between 50-1200 MPa.

44. The assembly of claim 43 wherein the third flexural modulus is between 1000-2500 MPa.

45. The assembly of claim 44 wherein the fourth flexural modulus is between 50-1200 MPa.

46. The assembly of claim 36 wherein the first polymeric layer and the third polymeric layer are comprised of a thermoplastic polyester or co-polyester.

47. The assembly of claim 46 wherein the second polymeric layer and the fourth polymeric layer are comprised of a polyurethane.

48. The assembly of claim 36 wherein the second polymeric layer is comprised of a perforated or breathable polyurethane.

49. The assembly of claim 36 wherein the composite material assembly is annealed at 65 degrees C. over a treatment time of 48 hours.

50. The assembly of claim 36 wherein the first, second, or third polymeric layer defines a pattern over at least a portion of the layer.

51. The assembly of claim 36 wherein the first, second, or third polymeric layer comprises a plurality of rigid materials deposited into or upon the layer to selectively rigidify the layer.

52. The assembly of claim 36 wherein the composite material assembly defines a mapped vector field applied upon a region of the composite material assembly, wherein the mapped vector field correlates with a desired force to be imparted by an aligner formed from the composite material assembly.

53. The assembly of claim 36 wherein the composite material assembly comprises a stress force ranging from 200-4000 grams at below 5% constant strain.

54. A composite material assembly, comprising:
a first polymeric layer having a first flexural modulus;
a second polymeric layer formed upon the first polymeric layer and having a second flexural modulus and different than the first flexural modulus;
a third polymeric layer formed upon the second polymeric layer such that the second polymeric layer is positioned between the first polymeric layer and the third polymeric layer, wherein the third polymeric layer has a third flexural modulus equivalent to the second flexural modulus; and
a fourth polymeric layer formed upon the third polymeric layer such that fourth polymeric layer is opposite to the first polymeric layer, wherein the fourth polymeric layer has a fourth flexural modulus equivalent to the first flexural modulus.

55. The assembly of claim 54 wherein any one of the polymeric layers defines perforations at least partially over.

56. The assembly of claim 54 wherein the assembly comprises a total thickness of about 725 microns.

57. The assembly of claim 54 wherein the first polymer layer and second polymeric layer each have a thickness of 100 micron or greater.

58. The assembly of claim 57 wherein the second polymeric layer and the third polymer layer each have a thickness of about 250 micron.

59. The assembly of claim 57 wherein the second polymer layer and the third polymeric layer each have a thickness of less than 200 micron.

60. The assembly of claim 54 further comprising an anti-microbial agent incorporated into the assembly.

61. The assembly of claim 54 wherein the first polymeric layer and the fourth polymeric layers are comprised of a polyurethane layer.

62. The assembly of claim 61 wherein the second polymeric layer and third polymer layers are comprised of a polyester or co-polyester layer.

63. The assembly of claim 54 wherein the first flexural modulus is about 150 MPa.

64. The assembly of claim 63 wherein the second flexural modulus is about 1500 MPa.

65. The assembly of claim 64 wherein the third flexural modulus is about 1500 MPa.

66. The assembly of claim 65 wherein the fourth flexural modulus is about 150 MPa.

67. The assembly of claim 54 wherein the second polymeric layer is comprised of a perforated or breathable polyurethane.

68. The assembly of claim 54 wherein the composite material assembly is annealed at 65 degrees C. over a treatment time of 48 hours.

69. The assembly of claim 54 wherein any of the polymeric layers defines a pattern over at least a portion of the layer.

70. The assembly of claim 54 wherein the any of the polymeric layers comprises a plurality of rigid materials deposited into or upon the layer to selectively rigidify the layer.

71. The assembly of claim 54 wherein the composite material assembly defines a mapped vector field applied upon a region of the composite material assembly, wherein the mapped vector field correlates with a desired force to be imparted by an aligner formed from the composite material assembly.

72. The assembly of claim 54 wherein the composite material assembly comprises a stress force ranging from 200-4000 grams at below 5% constant strain.
